(19) United States
(12) Patent Application Publication
(10) Pub. No.: US 2022/0213291 A1
(43) Pub. Date: Jul. 7, 2022

(54) HIGH JETNESS CARBON BLACK COMPOSITIONS

(71) Applicant: BIRLA CARBON U.S.A., INC., MARIETTA, GA (US)

(72) Inventors: DEEPAK TANDON, ACWORTH, GA (US); JUN TIAN, MARIETTA, GA (US)

(21) Appl. No.: 17/605,735

(22) PCT Filed: Apr. 23, 2020
(86) PCT No.: PCT/US2020/029636

§ 371 Date: Oct. 22, 2021

Related U.S. Application Data
(60) Provisional application No. 62/837,276, filed on Apr. 23, 2019.

(51) Int. Cl. C08K 3/04; C08K 5/20; C08J 3/22

(52) U.S. Cl. CPC C08K 3/041; C08K 3/04; C08K 5/20; C08J 2377/00; C08K 2201/011; C08J 2391/06; C08J 3/226

(57) ABSTRACT

High jetness carbon black compositions using carriers to improve dispersion and maintain good masstone and undertone properties.

### BACKGROUND

### Technical Field

The present disclosure relates to carbon black and compositions comprising carbon black that can be useful in applications requiring high jetness. The disclosure provides compositions useful in high jetness applications and method for the preparation and use thereof.

### Technical Background

Carbon blacks can be utilized in a variety of applications to impart color. The ability of a carbon black material or a composition comprising such a carbon black material to absorb light is referred to as jetness. Frequently, jetness refers to the color of a material containing carbon black as the only pigment, whereas tint can refer to the color developed by using blends of pigments. Higher jetness carbon blacks can result in darker compositions than low jetness carbon black materials. Spectrophotomers can be used to evaluate the jetness of a sample.

High jetness carbon blacks can also be difficult to disperse in some systems. Thus, there is a need for improved high jetness carbon blacks and compositions comprising such high jetness carbon blacks. These needs and other needs are satisfied by the compositions and methods of the present disclosure.

### SUMMARY

In accordance with the purpose(s) of the invention, as embodied and broadly described herein, this disclosure, in one aspect, relates to high jetness carbon black materials, to compositions comprising such high jetness carbon black materials, and methods for the preparation and use thereof.

In one aspect, the present disclosure provides a masterbead composition comprising from about 50 wt. % to about 80 wt. % of a carbon nanomaterial, and from about 20 wt. % to about 50 wt. % of an additive comprising one or more of the following: a mold release composition, a UV stabilizer, a heat stabilizer and/or antioxidant, and a flame retardant.

In another aspect, the present disclosure provides a masterbead composition comprising from about 50 wt. % to about 80 wt. % of a carbon black, and from about 20 wt. % to about 50 wt. % of an additive comprising one or more of the following: a mold release composition, a UV stabilizer, a heat stabilizer and/or antioxidant, and a flame retardant.

In another aspect, the present disclosure provides a masterbead composition comprising from about 50 wt. % to about 80 wt. % of a piano black, and from about 20 wt. % to about 50 wt. % of an additive comprising one or more of the following: a mold release composition, a UV stabilizer, a heat stabilizer and/or antioxidant, and a flame retardant.

In another aspect, the present disclosure provides a masterbead composition comprising from about 50 wt. % to about 80 wt. % of a carbon nanomaterial, and from about 20 wt. % to about 50 wt. % of an additive comprising a mold release composition.

In another aspect, the present disclosure provides a masterbead composition comprising from about 50 wt. % to about 80 wt. % of a carbon nanomaterial, and from about 20 wt. % to about 50 wt. % of an additive comprising an amide.

In another aspect, the present disclosure provides a masterbead composition comprising from about 50 wt. % to about 80 wt. % of a carbon nanomaterial, and from about 20 wt. % to about 50 wt. % of an additive comprising N,N′-ethylene bis(stearamide).

In one aspect, the present disclosure provides a masterbead composition comprising from about 50 wt. % to about 80 wt. % of a carbon nanomaterial, and from about 20 wt. % to about 50 wt. % of an additive comprising one or more of the following: a mold release composition, a UV stabilizer, a heat stabilizer and/or antioxidant, and a flame retardant, wherein when the masterbead composition is let-down to a carbon black loading of from about 0.5 wt. % to about 1.0 wt. % in a resin, has a jetness (L value) of less than about 3.5.

In another aspect, the present disclosure provides a method for preparing a masterbead composition, the method comprising contacting from about 50 wt. % to about 80 wt. % of a carbon nanomaterial, and from about 20 wt. % to about 50 wt. % of an additive comprising one or more of the following: a mold release composition, a UV stabilizer, a heat stabilizer and/or antioxidant, and a flame retardant, to form a masterbead having a plurality of finely divided particles.

### BRIEF DESCRIPTION OF THE DRAWINGS

The accompanying figures, which are incorporated in and constitute a part of this specification, illustrate several aspects and together with the description serve to explain the principles of the invention.

FIG. 1A is a scanning electron microscopy (SEM) image of a cross section of masterbatch extrudate prepared using 30 wt. % Raven 2500 Ultra carbon black in polyamide 6 resin, in accordance with various aspects of the present disclosure.

FIG. 1B is an SEM image of a cross section of masterbatch extrudate prepared using 20 wt. % Raven 5100 Ultra carbon black in polyamide 6 resin, in accordance with various aspects of the present disclosure.

FIG. 1C is an SEM image of a cross section of masterbatch extrudate prepared using 20 wt. % Raven 5100 Ultra carbon black and 10 wt. % N,N′-ethylene bis(stearamide) (EBS) in polyamide 6 resin, in accordance with various aspects of the present disclosure.

FIG. 2A is a transmission electron microscope (TEM) image of a portion of an injection molded color chip, prepared from a masterbead composition of Raven 2500 Ultra carbon black and EBS, let down to a carbon black loading of 0.5 wt. % using polyamide 6, in accordance with various aspects of the present disclosure.

FIG. 2B is a TEM image of a portion of an injection molded color chip, prepared from a masterbead composition of Raven 3000 Ultra carbon black and EBS, let down to a carbon black loading of 0.5 wt. % using polyamide 6, in accordance with various aspects of the present disclosure.

FIG. 2C is a TEM image of a portion of an injection molded color chip, prepared from a masterbead composition of Raven 5100 Ultra carbon black and EBS, let down to a carbon black loading of 0.5 wt. % using polyamide 6, in accordance with various aspects of the present disclosure.

FIG. 3 illustrates the color performance of let-down carbon black masterbatch compositions, in accordance with various aspects of the present disclosure.

FIG. 4 illustrates the color performance of carbon black containing masterbead compositions comprising an additive, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides high jetness carbon blacks and compositions comprising such high jetness carbon blacks, together with methods for preparing and use the same.

There is a growing market demand for high jetness engineering plastic compositions, particularly for fiber and automotive applications, which can be fulfilled with high surface area carbon blacks. These carbon black can also be referred to in the art as piano blacks. While these carbon blacks can impart excellent jetness properties to a resulting composition, the inherent particle size (i.e., fineness) and high surface area can make them very difficult to disperse. In one aspect, high van der Waals interactions between carbon black aggregates and limited affinity between the carbon black and traditional polymer resins can require high energy inputs to achieve good dispersion within the polymer system. Good dispersions are important for these applications, but can be challenging when using conventional compounding practices.

Applications that utilize carbon black filled engineering resins typically require a package of additives to overcome the challenges in dispersing and processing the carbon black into the resin composition and to optimize their performance for specific applications. While the specific additives or combinations of additives can vary, depending on the resin or resins used and the specific application, these additive compositions can be characterized based on the functions or properties they impart to the final resin/carbon black compositions. In various traditional systems, one or more of the following additives can be used: (1) mold release compositions that can be used to prevent finished parts from sticking to metal surfaces in the extrusion or molding process, (2) UV stabilizers used to extend the outdoor life of plastic parts, (3) heat stabilizers and/or antioxidants used to protect resins from thermal and oxidative degradation during processing, and (4) flame retardants used to prevent fires or slow their spread. In other aspects, other additives can be used in addition to or in lieu of any of those recited above. In still other aspects, multiple additives of a single type or multiple additives or various types can be used in a composition.

Carbon black materials can be inherently difficult to handle, due to their fineness and dusting. They can also be difficult to disperse into plastics. Achieving a good carbon black dispersion in most resin systems typically requires high energy mixing. Many users of carbon black materials lack the expensive equipment and/or expertise to efficiently disperse carbon black into these resin systems. As a result, some users opt to use masterbatch compositions, where carbon blacks are dispersed into resin systems at concentrations higher than needed for use in producing final products. These concentrates can be prepared by companies that possess the equipment and knowledge to efficiently disperse the carbon black materials. Once the carbon black is well dispersed, even at elevated concentrations, additional resin can be added to dilute the carbon black concentration. End users can purchase carbon black masterbatch compositions and then dilute, or let-down, the composition by adding additional resin. The energy needed to incorporate the additional resin and disperse the pre-dispersed carbon black through the remaining resin is significantly less than that required to form the masterbatch. The masterbach material also has the added benefit of being easier to handle and exhibits less dusting since the carbon black is incorporated into the resin matrix. The present disclosure provides an alternative to traditional masterbatch technology, but providing a pre-dispersed carbon black that does not contain resin, but that is similarly easy to handle and can be easily dispersed into a resin system by an end-user.

In one aspect, the present disclosure provides a combination of carbon black, one or more additives, and optionally a resin or plastic material. In such an aspect, the one or more additives are intended to improve the dispersion of the carbon black in the resin. In another aspect, the composition does not comprise a resin, and only comprises one or more carbon blacks and one or more additives. In some aspects, one or more of these additives may be a conventional additive used for one or more of the purposes recited above. In such aspects, the present invention contemplates use of such additive or additives at higher concentrations than in conventional processes and applications, and as a carrier of the carbon black, not merely as a mold release agent, UV stabilizer, heat stabilizer, and/or flame retardant. Thus, in some aspects, the concentration of any additive or of the combination of additives is intended to be greater than that used in the art for their conventional purpose.

In one aspect, the additive or mixture of additives can be utilized with a carbon black and a resin to improve dispersion at the compounding stage. In another aspect, a carbon black can be precontacted with an additive or mixture of additives, prior to contacting with a resin. Such an additive precontacted carbon black can, in various aspects, be referred to as a masterbead. In such an aspect, the treated carbon black can be packaged and/or sold to be subsequently mixed with a resin. In yet another aspect, a masterbatch (i.e., concentrate) can be prepared containing the carbon black, resin, and additive or additives, wherein the carbon black is well dispersed within the masterbatch composition. In such an aspect, a final user can let down the masterbatch by contacting the masterbatch composition with additional resin so as to dilute the concentrated carbon black and/or additive(s) in the masterbatch composition.

While not wishing to be bound by theory, it is believed that the use of carbon blacks and additives as described herein can improve miscibility of the carbon black in a resin system. In another aspect, it is believed that the carbon black and additive compositions described herein can comprise a bi-continuous morphology.

The carbon black of the present invention can comprise any carbon black suitable for use in an application requiring high jetness. In one aspect, the carbon black is a furnace carbon black. In one aspect, a single high jetness carbon black can be utilized. In other aspects, two or more carbon blacks, wherein at least one of the carbon blacks is a high jetness carbon black, can be utilized. In still other aspects, two or more high jetness carbon blacks can be utilized. In yet another aspect, the high jetness carbon black can replace other all or a portion of traditional carbon blacks and/or other pigments or dyes in a composition.

In one aspect, the present invention comprises a piano black. In various aspects, a piano black comprises a high surface area carbon black, for example, having a nitrogen surface area (NSA) of at least about 175, at least about 200, at least about 225, at least about 250, at least about 300, at least about 350, at least about 400, at least about 450, at least about 500, or greater m²/g. In another aspect, the piano black comprises a carbon black having a NSA of from about 175 to about 700 m²/g, from about 200 to about 600 m²/g, from about 250 to about 550 m²/g, from about 300 to about 600 m²/g, from about 350 to about 600 m²/g, from about 400 to about 650 m²/g, from about 450 to about 575 m²/g, or from about 500 to about 650 m²/g. In other aspects, a piano black can comprise a carbon black having a statistical thickness surface area (STSA) of from about 150 to about 400 m²/g, or from about 200 to about 350 m²/g. In yet another aspect, a piano black can have an oil absorption number (OAN) of from about 60 to about 120 ml/100 g, or from about 65 to about 105 ml/100 g, or from about 80 to about 105 ml/100 g. In other aspects, a piano black can have a NSA, STSA, and/or OAN outside of the ranges recited herein. In other aspects, a piano black can have an unmodified surface. In still other aspects, a piano black can have a modified surface, for example oxidized via ozone, acid, or hydrogen peroxide, or functionalized with other groups (e.g., amines, carboxylic acids, etc.) There are numerous examples of carbon black surface modification in the literature, each of which are contemplated with this invention. Carbon blacks, such as those for use in the present invention, are commercially available from, for example, Birla Carbon U.S.A., Inc., Marietta, Ga., USA.

NSA refers to nitrogen surface area, which can be measured according to ASTM D6556, and is a measure of the total surface area of a carbon black sample accessible to nitrogen, including porosity, based on B.E.T. theory. STSA refers to the statistical thickness surface area or external surface area of a carbon black sample that is accessible to a plastic or other medium, and can be measured according to ASTM D6556. OAN refers to oil absorption number and is intended to provide an indication of the structure, or aggregate size, of a carbon black grade. OAN can be measured according to ASTM D2414.

In other aspects, all or a portion of the carbon black of the present invention can be replaced with one or more other carbon nanomaterials, such as, for example, single-walled carbon nanotubes, multi-walled carbon nanotubes, carbon fibers, and graphenes. Thus, in one aspect, the composition can comprise a carbon nanomaterial and one or more additives.

In one aspect, the present invention also comprises a conventional mold release additive or an analog or derivative thereof. In various aspects, such a mold release agent can comprise an amide, such as a primary, secondary, and/or tertiary amide, or an amine. In one aspect, the additive can comprise ethylene bis stearamide (EBS) (referenced below as compound (I)). In another aspect, the additive can comprise a wax, such as, for example, a polyethylene wax. In still other aspects, the additive can comprise one or more other conventional mold release agents. In other aspects, any one or more of the individual additives recited or contemplated herein can be combined to form the additive. In one aspect, a plurality of mold release agents or other additives can be utilized together. A mold release agent is typically chemically compatible with the resin matrix and often has a lower molecular weight than the resin compound.

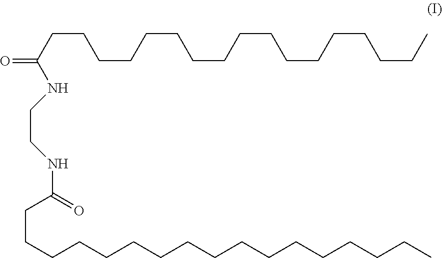 [SMILES: CCCCCCCCCCCCCCCCCC(=O)NCCNC(=O)CCCCCCCCCCCCCCCCC]

In another aspect, the present invention comprises a UV stabilizer additive or an analog or derivative thereof. In various aspects, such a UV stabilizer additive can comprise benzotriazoles, hindered amine light stabilizers (HALS), and/or other conventional UV stabilizer additives. In one aspect, a plurality of UV stabilizer additives or other additives can be utilized together.

In another aspect, the present invention comprises a flame retardant additive or an analog or derivative thereof. In various aspects, a flame retardant additive can be used alone or in combination with other flame retardant additives or other additives.

In another aspect, the present invention comprises a mixture of any two or more types of additives recited herein or commonly used in the processing of materials that comprise piano blacks. In various aspects, the composition can comprise any mixture of additive materials. In another aspect, any one or more of the additives or types of additives recited herein can be specifically excluded from the composition.

While these additives may be used in the processing of conventional carbon black containing resin materials, they are typically used at low levels, such as for example, less than about 1,000 ppm or about 500 ppm. Since these additive materials typically have lower molecular weights than, and are typically soluble in and/or compatible with the resins with which they will be mixed, the present invention contemplates their use as a carrier to prepare a masterbead or masterbatch material, or as a surface modifier for carbon blacks to ease and improve wettability and dispersability.

### Masterbead Compositions

In various aspects, the weight ratio of carbon black to any individual additive or the combination of additives, if multiple additives are present, can be from about 95:5 (carbon black:additive) to about 50:50, for example, about 95:5, 90:10, 85:15, 80:20, 75:25, 70:30, 65:35, 60:40, 55:45, or 50:50. In other aspects, the weight ratio of carbon black to any individual additive or combination of additives, can be from about 90:10 to about 50:50, from about 85:15 to about 40:60, from about 75:25 to about 50:50, from about 70:30 to about 45:55, from about 60:40 to about 40:60, from about 80:20 to about 30:70, or from about 75:25 to about 60:40. In other aspects, the weight ration of carbon black to any individual additive or combination of additives can be greater than or less than any value or range recited herein. In another aspect, the ratio of carbon black to additive can be about 5:1, 4.5:1, 4:1, 3.5:1, 3:1, 2.5:1, 2:1, 1.5:1, 1:1, 1:1.2, 1:1.4, 1:1.6, 1:1.8, 1:2, 1:2.1, 1:2.2, 1:2.3, 1:2.4, 1:2.5, 1:2.6, 1:2.7, 1:2.8, 1:2.9, 1:3, 1:3.2, 1:3.4, 1:3.6, 1.3.8, 1:4, 1:4.2, 1:4.4, 1:4.6, 1:4.8, or 1:5. In other aspects, the ratio of carbon black to additive or the combination of additives can be higher or lower than any particular value or range recited herein. In one aspect, the weight ratios recited above can refer to masterbead compositions comprising carbon black and one or more additives. In another aspect, the weight ratios of carbon black to additives recited above can refer to masterbatch compositions also comprising one or more resin materials.

In one aspect, an additive or mixture of additives can be present in a masterbead composition at a concentration of at least about 5,000 ppm, at least about 6,000 ppm, at least about 7,000 ppm, at least about 8,000 ppm, at least about 9,000 ppm, at least or about 10,000 ppm, or greater in a final composition. In another aspect, an additive or mixture of additives can be present in a range from any of the lower end values recited above up to about 10,000 ppm, 20,000 ppm, 30,000 ppm, 40,000 ppm, 50,000 ppm, 75,000 ppm, 100,000 ppm, 150,000 ppm, 200,000 ppm, 250,000 ppm, 300,000 ppm, 350,000 ppm, 400,000 ppm, 450,000 ppm, 500,000 ppm, or greater.

In one aspect, when the one or more additives and piano blacks are used as described herein, the loading of carbon black can be increased to at least about 40 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, or greater. In another aspect, the loading of carbon black can be increased to a level of from about 40 wt. % to about 75 wt. %, from about 40 wt. % to about 80 wt. %, from about 40 wt. % to about 85 wt. %, from about 50 wt. % to about 85 wt. %, from about 50 wt. % to about 75 wt. %, from about 55 wt. % to about 75 wt. %, from about 55 wt. % to about 80 wt. %, from about 60 wt. % to about 80 wt. %, from about 60 wt. % to about 85 wt. %, from about 60 wt. % to about 75 wt. %, from about 65 wt. % to about 85 wt. %, from about 65 wt. % to about 80 wt. %, or from about 65 to about 75 wt. %. In other aspects, the amount of carbon black in a masterbead composition can be from about 60 wt. % to about 80 wt. %, and the amount of additive can be from about 20 wt. % to about 40 wt. %. In other aspects, the carbon black and/or additive loading can be higher or lower than any specific value or range recited herein. In another aspect, the use of a high loading of carbon black, as recited herein, can be used while still maintaining excellent dispersability.

### Masterbatch Compositions

As noted above, a masterbatch composition can be prepared comprising carbon black, one or more additives as described herein, and one or more resin materials. In one aspect, a masterbatch can be prepared by contacting one or more resin materials with a masterbead, as described above. In another aspect, a masterbatch composition can be prepared by contacting carbon black, one or more additives as described herein, and one or more resin materials. In various aspects, the resin material of a masterbatch composition, or as used to let down as masterbatch composition, can comprise any conventional resin material, including for example, polycarbonates, polyamides, polyolefins, such as polyethylene and polypropylene, polyesters, such as polyethylene terephthalates, co-polymers, such as styrene-acrylonitrile, and terpolymers such as acrylonitrile butadiene styrene. In other aspects, other resin materials not specifically recited herein can be utilized in addition to or in lieu of any resin material recited herein. In one aspect, a carbon black and/or an additive can be selected based on their compatibility and/or miscibility with a particular resin system. For example, Raven 3500 Ultra is an ozonated carbon black, having oxygen containing functional groups on its surface. The ozonation can improve the carbon black's chemical compatibility with certain resins, such as polyamides, and thus enable improved dispersion of the carbon black within the resin.

In various aspects, the ratio of carbon black to any one or more additives in a masterbatch composition can be the same as that in a masterbead composition comprising carbon black and one or more additives, as described above. In other aspects, the concentration of carbon black and the one or more additives can be reduced proportionately as resin material is added to the composition. For example, a masterbead composition comprising 70 wt. % carbon black and 30% wt. % additives can be contacted with a portion of resin material so as to provide a composition that comprises 50 wt. % resin, 35 wt. % carbon black and 15 wt. % additive. In various aspects, the carbon black in a masterbatch composition can comprise from about 20 wt. % to about 50 wt. %, from about 20 wt. % to about 40 wt. %, from about 25 wt. % to about 60 wt. %, from about 30 wt. % to about 40 wt. %, or from about 20 wt. % to about 35 wt. % of the composition. In other aspects, the carbon black can be present in a greater or lesser concentration that the values or ranges described herein. In another aspect, the additive or mixture of additives in a masterbatch composition can be present at a concentration of from about 5 wt. % to about 35 wt. %, from about 5 wt. % to about 10 wt. %, from about 5 wt. % to about 20 wt. %, from about 10 wt. % to about 35 wt. %, from about 10 wt. % to about 25 wt. %, from about 10 wt. % to about 20 wt. %, from about 15 wt. % to about 25 wt. %, from about 15 wt. % to about 30 wt. %, from about 20 wt. % to about 35 wt. %, or from about 25 wt. % to about 35 wt. %. In another aspect, the additive or mixture of additives in a masterbatch composition can be present at a concentration greater than or less than any particular value or range recited herein. In still other aspects, the resin or mixture of resins in a masterbatch composition can comprise from about 40 wt. % to about 90 wt. %, from about 50 wt. % to about 80 wt. %, from about 50 wt. % to about 70 wt. %, from about 45 wt. % to about 75 wt. %, from abot 55 wt. % to about 85 wt. %, from about 50 wt. % to about 60 wt. %, from about 60 wt. % to about 75 wt. %, or from about 65 wt. % to about 80 wt. % of the masterbatch composition. In still other aspects, the resin or mixture of resins in a masterbatch composition can be present at a concentration greater than or less than any particular value or range recited herein.

In various aspects, a masterbatch composition and/or a final composition, wherein a masterbatch or masterbead is contacted with resin to achieve a final target resin concentration, can be prepared using one or more conventional mixing techniques, including for example, a twin-screw extruder, and/or a high torque compounding machine, such as, for example, a Farrel continuous mixer or a Banbury mixer. It is understood that different mixing and/or compounding equipment can handle different volumes and concentrations of materials, and one of skill in the art, in possession of this disclosure, could readily select an appropriate mixing and/or compounding technique and/or equipment for a particular material. For example, it may be possible to obtain higher carbon black loadings using a Banbury type mixer than with a twin screw extruder or continuous mixer.

### Final Composition

As noted above, a final composition can be prepared wherein one or more resins are added to a mixture of carbon black and one or more additives, as described herein, so as to achieve a target final resin concentration. In such aspects, an additive or mixture of additives can be present in a final composition (e.g., a let-down final composition) at a concentration of from about 2,000 ppm to about 10,000 ppm, from about 6,000 to about 10,000 ppm, from about 7,000 ppm to about 15,000 ppm, from about 5,000 ppm to about 9,000 ppm, from about 8,000 ppm to about 12,000, or from about 10,000 to about 50,000 ppm. In another aspect, such a final composition can have a carbon black concentration of about 0.5 wt. %, 0.6 wt. %, about 0.7 wt. %, about 0.8 wt. %, about 0.9 wt. %, about 1 wt. %, about 1.1 wt. %, about 1.2 wt %, about 1.3 wt %, about 1.4 wt. %, about 1.5 wt. %, about 1.6 wt. %, about 1.7 wt %, about 1.8 wt. %, about 1.9 wt. %, about 2 wt. %, about 2.1 wt. %, about 2.2 wt. %, about 2.3 wt. %, about 2.4 wt. %, about 2.5 wt. %, or greater. In other aspects, the concentration of carbon black and/or an additive or mixture of additives can be higher than or lower than any particular value or range recited herein.

In one aspect, a let-down of a masterbatch sample prepared in accordance with the present invention can comprise about 1 wt. % carbon black and less than about 5,000 ppm additive, such as, for example, EBS, in a final application. In another aspect, such a composition can exhibit good mold release properties, exhibit excellent carbon black dispersion, and impart high jetness to the resulting application.

In yet another aspect, the additive or combination of additives described herein can be utilized in the beading process, instead of or in addition to incorporation into a mixture prior to compounding. In such an aspect, the additive or additive package can be pre-mixed with the carbon black to provide a readily dispersible carbon black for an intended resin or application.

In one aspect, the use of an additive or combination of additives are described herein can improve dispersion of a carbon black in a resin material, while maintaining good masstone and/or undertone properties. In other aspect, the masterbead of the present invention can exhibit improved handling properties while also improving dispersion in a resulting material. In such an aspect, a masterbead will exhibit reduced dusting and/or fines when handled or conveyed, resulting in improved environmental conditions and reduced product loss, as compared to conventional carbon black materials.

### Color Properties

Carbon blacks can impart various color properties to materials in which they are mixed. For example, carbon blacks are often added to plastics to impart a black color (“jetness”). Carbon blacks with higher jetness appear blacker than those having ower jetness characteristics. While traditionally thought of as black, carbon blacks can impart colors ranging from blue-black to brown-black, referred to as the undertone, when compounded into various materials.

These color properties can be affected by the primary particle size, surface area, and aggregate size of the particular carbon black. Ultimately, the dispersion of carbon blacks in a resin or other matrix can greatly influence the color properties imparted to the resulting composition. Color properties can be quantitatively measured using various instrumental methods. Hunter color analyzers, such as the Hunter Lab Compuscan reflectance spectrometer in a specular excluded mode at a 0/45° geometry, utilize a three dimensional space to define color properties. Along one axis, L values range from 0 (jet black) to 100 (white) and indicate color density; along a second axis, “a” values range from −a (green) to +a (red); and along a third axis, “b” values range from −b (blue) to +b (yellow). In carbon blacks, the undertone is typically referred to as blue or brown, relative to a control sample.

In various aspects, se of the masterbeads or masterbatch compositions described herein, can provide improved dispersion of carbon blacks within a resin system and/or improved color performance, just as improved jetness. In various aspects, a carbon black filled resin system comprising one or more additives, when let down to a carbon black concentration of 0.5 wt. % to 1.0 wt. %, as described herein, can exhibit an L value (jetness) of less than about 5, less than about 4.5, less than about 4, less than about 4, less than about 3.8, less than about 3.6, less than about 3.4, less than about 3.4, less than about 3.2, less than about 3.0, less than about 2.9, less than about 2.8, less than about 2.7, less than about 2.6, or less than about 2.5. In other aspects, such a composition can exhibit an L value of from about 2.5 to about 5, from about 2.5 to about 4.5, from about 2.5 to about 4, from about 2.5 to about 3.8, from about 2.5 to about 3.6, from about 2.5 to about 3.4, from about 2.5 to about 3.2, from about 2.5 to about 3, from 2.5 to about 2.9, from 2.5 to about 2.8, from about 2.5 to about 2.7, or from about 2.5 to about 2.6. In one aspect, such a system can comprise a polyamide resin, such as polyamide 6. In other aspects, such a system can comprise one or more other resin materials.

Thus, in various aspect, the masterbead technology of the present disclosure can provide one or more of: improved dispersion in resin systems, improved jetness, reduced dusting, and improved handling characteristics to a carbon black.

### EXAMPLES

Various exemplary embodiments of the invention are detailed below. These embodiments are intended to be exemplary and are not intended to limit the scope of the invention. For each of the following examples, unless indicated to the contrary, the following processes, equipment, and conditions were utilized. Compounding was performed with a PRISM twin-screw extruder (16 mm, 25:1) set at 260° C. in polyamide 6 resin (AdvanSix, Aegis, H8202NLB, % 96 SAV=2.61) immediately followed by pelletizing. Prior to compounding, the carbon black and PA6 resin were dried in an oven at 160° C. overnight and in vacuum oven at 80° C. for ˜three days respectively to minimize the moisture content.

### Example 1—Masterbatch Compositions and Analysis Via SEM

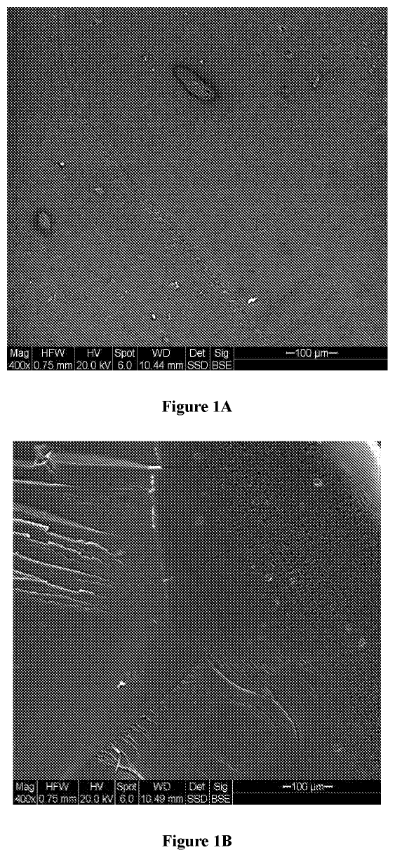

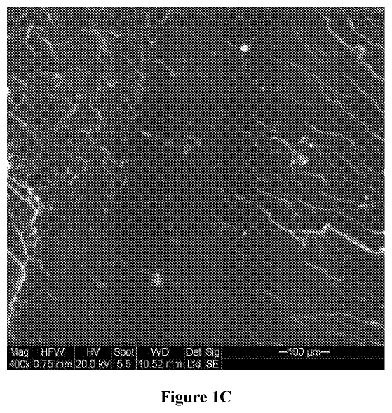

A first masterbatch (“A”) was prepared using a twin screw extruder and polyamide 6 resin, as described above, using 30 wt. % of Raven 2500 Ultra carbon black. The masterbatch extrudate was cut with a razor blade and cross sections examined using a scanning electron microscope (SEM) to assess the carbon black dispersion. The examined extrudate contained several areas of poorly dispersed carbon black, which can be common for resin systems comprising high surface area carbon blacks, as illustrated in FIG. 1A.

A second masterbatch (“B”) was prepared, as described above, but using 20 wt. % Raven 5100 Ultra carbon black in polyamide 6 resin. The masterbatch extrudate from a twin screw extruder was examined, and the extrudate similarly had several areas of poorly dispersed carbon black, as illustrated in FIG. 1B.

A third masterbatch (“C”) was prepared, as described above, but using 20 wt. % Raven 5100 Ultra carbon black with 10 wt. % N,N′-ethylene bis(stearamide) (EBS, available from Sigma Aldrich) in polyamide 6 resin. The masterbatch extrudate from a twin screw extruder was examined and the carbon black dispersion was observed to be significantly improved over that in masterbatch B that did not contain EBS.

### Example 2—Masterbatch Analysis Via TEM

Carbon black masterbead compositions using Raven 2500 Ultra, Raven 3000 Ultra, and Raven 5100 Ultra carbon blacks, each comprising from about 55 wt. % to about 65 wt. % carbon black with the balance comprising N,N′-ethylene bis(stearamide). Each masterbead composition was subsequently let down to 0.5 wt. % carbon black loading using polyamide 6 resin, and then injection molded at 260° C. into color chips. Slices of the resulting chips were prepared and analyzed via transmission electron microscopy (TEM) to evaluate carbon black dispersion.

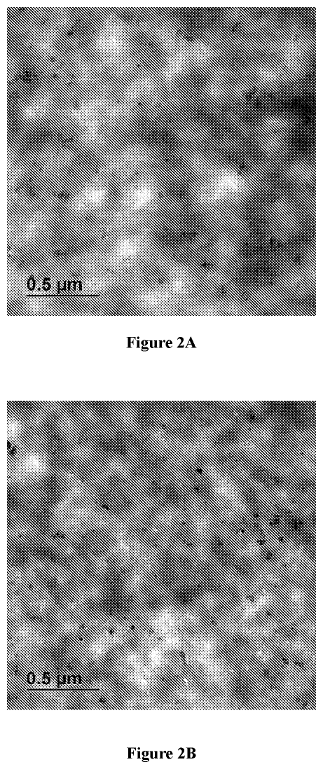

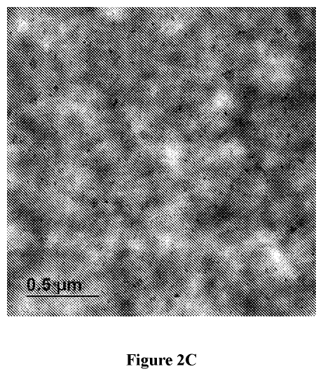

Each of the let down compositions exhibited excellent dispersions of carbon black, as illustrated in FIGS. 2A, 2B, and 2C, respectively, illustrating the benefit of the additive and masterbead technology on improving carbon black dispersion.

### Example 3—Color Performance

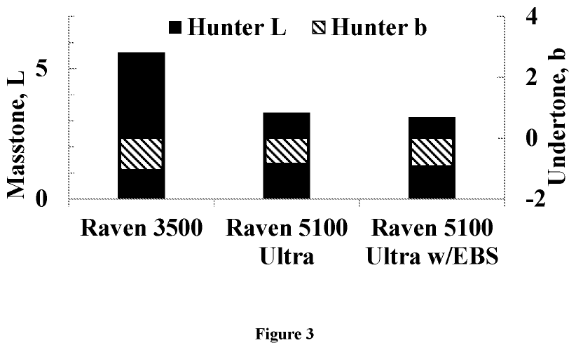

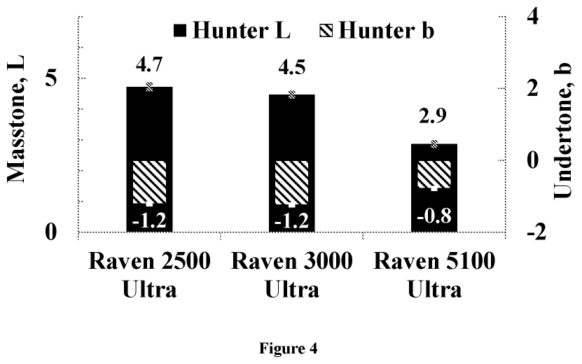

Three masterbatch compositions were prepared, as in Example 1, using three piano blacks (Raven 3500 Ultra, Raven 5100 Ultra, and Raven 5100 with EBS), each in polyamide 6. The carbon black loading in each masterbatch composition was 20 wt. % and the EBS concentration in the third masterbatch composition was 10 wt. %. Each of the three masterbatch compositions was then let down to 1.0 wt. % carbon black loading, and analyzed using a Hunter color analyzer, as described herein. L values for the three compositions were 5.6 (Raven 3500 Ultra), 3.3 (Raven 5100 Ultra), and 3.1 (Raven 5100 Ultra with EBS). As illustrated in FIG. 3, the piano blacks all exhibited excellent jetness and blue undertone color performance, consistent with their surface area. Raven 5100 Ultra was significantly jetter than Raven 3500 Ultra, as Raven 5100 Ultra has a much higher surface area. Analysis of the masterbatch compositions by SEM indicates that the presence of EBS improves the macrodispersion of the Raven 5100 Ultra carbon black with less carbon black agglomerates in the masterbatch. This improved dispersion and lack of agglomerates can be critical in certain automotive applications.

### Example 4—Color Performance

The three color chips prepared in Example 2, each having a carbon black concentration of 0.5 wt. % and being prepared from a masterbead containing carbon black and EBS, were analyzed using a Hunter color analyzer, as described herein. L values for the three compositions were 4.7 (Raven 2500 Ultra with EBS), 4.5 (Raven 3000 Ultra with EBS), and 2.9 (Raven 5100 Ultra with EBS). As in Example 3, each of these high color carbon blacks offered excellent jetness and undertone color performance. With increasing surface areas from Raven 2500 Ultra to Raven 3000 Ultra to Raven 5100 Ultra, the carbon blacks exhibited improved jetness. This jetness was achieved through excellent dispersion resulting from the addition of EBS, as revealed in the TEM micrographs in FIGS. 2A-2C.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A masterbead composition comprising from about 50 wt. % to about 80 wt. % of a carbon nanomaterial, and from about 20 wt. % to about 50 wt. % of an additive comprising one or more of the following: a mold release composition, a UV stabilizer, a heat stabilizer and/or antioxidant, and a flame retardant.

2. The masterbead composition of claim 1, wherein the carbon nanomaterial comprises at least about 60 wt. % of the composition.

3. The masterbead composition of claim 1, wherein the carbon nanomaterial comprises at least about 70 wt. % of the composition.

4. The masterbead composition of claim 1, wherein the carbon nanomaterial comprises at least about 75 wt. % of the composition.

5. The masterbead composition of claim 1, wherein the carbon nanomaterial comprises a carbon black.

6. The masterbead composition of claim 5, wherein the carbon black comprises a furnace carbon black.

7. The masterbead composition of claim 5, wherein the carbon black is oxidized.

8. The masterbead composition of claim 5, wherein the carbon black comprises a piano black.

9. The masterbead composition of claim 1, wherein the carbon nanomaterial comprises a carbon nanotube.

10. The masterbead composition of claim 1, wherein the additive comprises an amide.

11. The masterbead composition of claim 1, wherein the additive comprises N,N′-ethylene bis(stearamide).

12. The masterbead composition of claim 1, wherein the additive comprises a wax.

13. The masterbead composition of claim 1, wherein the composition does not comprise a wax.

14. The masterbead composition of claim 1, wherein the composition does not comprise a resin.

15. The masterbead composition of claim 1, consisting essentially of carbon black and an amide.

16. The masterbead composition of claim 1, which when let-down to a carbon black loading of from about 0.5 wt. % to about 1.0 wt. % in a resin, has a jetness (L value) of less than about 3.5

17. The masterbead composition of claim 16, wherein the resin comprises a polyamide resin.

18. The masterbead composition of claim 16, having a jetness (L value) of less than about 3.

19. A method for preparing a masterbead composition, the method comprising contacting from about 50 wt. % to about 80 wt. % of a carbon nanomaterial, and from about 20 wt. % to about 50 wt. % of an additive comprising one or more of the following: a mold release composition, a UV stabilizer, a heat stabilizer and/or antioxidant, and a flame retardant, to form a masterbead having a plurality of finely divided particles.

20. The method of claim 19, wherein the carbon nanomaterial comprises a carbon black.
